(19) United States
(12) Patent Application Publication
(10) Pub. No.: US 2025/0213973 A1
(43) Pub. Date: Jul. 3, 2025

(54) FACE PROCESSING METHOD AND APPARATUS, COMPUTER DEVICE, AND STORAGE MEDIUM

(71) Applicant: Beijing Zitiao Network Technology Co., Ltd., Beijing (CN)

(72) Inventors: Hao JIANG, Beijing (CN); Xiang WEN, Beijing (CN); Di TANG, Beijing (CN); Feng WANG, Beijing (CN); Qi WEN, Beijing (CN); Guozhi XU, Beijing (CN); Jiaqing ZHOU, Beijing (CN)

(21) Appl. No.: 18/848,116

(22) PCT Filed: Mar. 7, 2023
(86) PCT No.: PCT/CN2023/080028

§ 371 Date: Sep. 17, 2024

(30) Foreign Application Priority Data
Mar. 30, 2022 (CN) 202210325620.7

(51) Int. Cl. A63F 13/50; G06T 17/20; G06V 10/77; G06V 10/774; G06V 40/16

(52) U.S. Cl. CPC A63F 13/50; G06T 17/20; G06V 10/7715; G06V 10/774; G06V 40/165; G06V 40/171

(57) ABSTRACT

The present disclosure provides a face processing method and apparatus, a computer device, and a storage medium. The method includes: obtaining three-dimensional face reconstruction coefficients of a three-dimensional face reconstruction model corresponding to face driving image data, and face posture information; determining initial character customization parameter information based on the face driving image data; and determining target character customization parameter information of the face driving image data based on the initial character customization parameter information, the three-dimensional face reconstruction coefficients, and the face posture information.

### CROSS-REFERENCE TO RELATED APPLICATIONS

The present application claims priority to Chinese Patent Application No. 202210325620.7, filed with the China National Intellectual Property Administration on Mar. 30, 2022, and entitled “FACE PROCESSING METHOD AND APPARATUS, COMPUTER DEVICE, AND STORAGE MEDIUM”, which is incorporated herein by reference in its entirety.

### TECHNICAL FIELD

The present disclosure relates to the field of computer technologies, and in particular, to a face processing method and apparatus, a computer device, and a storage medium.

### BACKGROUND ART

With the rapid development of online games, an increasing number of games have provided a character customization feature to help control persons customize personalized game characters.

When corresponding game characters are created based on facial data, it is worth studying how to make the game characters created using the character customization feature more similar to faces of the control persons.

### SUMMARY OF THE INVENTION

Embodiments of the present disclosure provide at least a face processing method and apparatus, a computer device, and a storage medium.

According to a first aspect, an embodiment of the present disclosure provides a face processing method. The method includes:
obtaining three-dimensional face reconstruction coefficients of a three-dimensional face reconstruction model corresponding to face driving image data, and face posture information, where the three-dimensional face reconstruction coefficients include weight coefficients of target basis vectors of reference three-dimensional faces used when three-dimensional face reconstruction is performed on the face driving image data;
determining initial character customization parameter information based on the face driving image data; and
determining target character customization parameter information of the face driving image data based on the initial character customization parameter information, the three-dimensional face reconstruction coefficients, and the face posture information, where the target character customization parameter information is used to render a virtual character in a virtual scene.

In an optional implementation, the target character customization parameter information is obtained using a pre-trained face processing model;
the face processing model includes a character customization parameter prediction model and a parameter integration model; and
the character customization parameter prediction model is used to generate the initial character customization parameter information based on the face driving image data, and the parameter integration model is used to generate the integrated target character customization parameter information based on the initial character customization parameter information, the three-dimensional face reconstruction coefficients, and the face posture information.

In an optional implementation, the character customization parameter prediction model is trained by the following steps:
extracting a first image feature of a face driving image data sample, first facial key point information corresponding to a target part in the face driving image data sample, and face sample reconstruction coefficients and face posture information of a three-dimensional face reconstruction model corresponding to the face driving image data sample;
inputting the first image feature into a character customization parameter prediction model to be trained, to obtain first predicted character customization parameter information corresponding to the face driving image data sample; and inputting the first facial key point information into the character customization parameter prediction model to be trained, to obtain second predicted character customization parameter information corresponding to the face driving image data sample;
inputting the first predicted character customization parameter information, the face sample reconstruction coefficients, and the face posture information into a pre-trained generator to obtain a first generated face image; and inputting the second predicted character customization parameter information, the face sample reconstruction coefficients, and the face posture information into the pre-trained generator to obtain a second generated face image;
determining first loss information based on a second image feature of the second generated face image and the first image feature; and determining second loss information based on second facial key point information of the second generated face image and the first facial key point information; and
adjusting weight parameter information in the character customization parameter prediction model to be trained based on the first loss information and the second loss information, to obtain the trained character customization parameter prediction model.

In an optional implementation, the extracting a first image feature of a face driving image data sample includes:
inputting the face driving image data sample into a pre-trained face recognition model to obtain the first image feature of the face driving image data sample; and
before the determining first loss information based on a second image feature of the second generated face image and the first image feature, the method further includes:
inputting the second generated face image into the pre-trained face recognition model to obtain the second image feature of the second generated face image.

In an optional implementation, the extracting first facial key point information corresponding to a target part in the face driving image data sample includes:
inputting the face driving image data sample into a pre-trained facial key point detection model to obtain the first facial key point information corresponding to the target part in the face driving image data sample; and
before the determining second loss information based on second facial key point information of the second generated face image and the first facial key point information, the method further includes:
performing skinning on the second predicted character customization parameter information, the face sample reconstruction coefficients, and the face posture information to obtain mesh information corresponding to the second generated face image, where the mesh information includes position information of feature points in a three-dimensional face reconstruction model corresponding to the second generated face image; and
determining the second facial key point information corresponding to the second generated face image based on the mesh information and preset camera parameter information.

In an optional implementation, the step of training the character customization parameter prediction model further includes:
obtaining a first facial area image of the face driving image data sample;
inputting the first facial area image into the character customization parameter prediction model to be trained, to obtain third predicted character customization parameter information corresponding to the face driving image data sample;
inputting the third predicted character customization parameter information, the face sample reconstruction coefficients, and the face posture information into the pre-trained generator to obtain a third generated face image; and
determining third loss information based on pixel information of a second facial area image of the third generated face image and pixel information of the first facial area image; and
the adjusting weight parameter information in the character customization parameter prediction model to be trained based on the first loss information and the second loss information, to obtain the trained character customization parameter prediction model includes:
adjusting the weight parameter information in the character customization parameter prediction model to be trained based on the first loss information, the second loss information, and the third loss information, to obtain the trained character customization parameter prediction model.

In an optional implementation, the obtaining a first facial area image of the face driving image data sample includes:
inputting the face driving image data sample into a pre-trained face segmentation model to obtain the first facial area image of the face driving image data sample; and
before the determining third loss information based on pixel information of a second facial area image of the third generated face image and pixel information of the first facial area image, the method further includes:
inputting the third generated face image into the pre-trained face segmentation model to obtain the second facial area image of the third generated face image.

In an optional implementation, the pre-trained generator includes a pre-trained pixel-to-pixel model; and the pixel-to-pixel model is trained by the following steps:
obtaining a plurality of parameter samples, where each of the parameter samples includes character customization parameter information, and reconstruction coefficient information and the face posture information of the three-dimensional face reconstruction model;
inputting the character customization parameter information in each of the parameter samples into a game engine to obtain a fourth generated face image;
performing skinning on each of the parameter samples to obtain skinned mesh information;
performing differentiable rendering on the skinned mesh information to obtain a fifth generated face image;
inputting the fifth generated face image into a pixel-to-pixel model to be trained, to obtain a sixth generated face image;
for each of the parameter samples, determining perceptual loss information based on pixel information of the fourth generated face image and pixel information of the sixth generated face image that are obtained for the parameter sample; and
adjusting model parameter information of the pixel-to-pixel model based on the perceptual loss information, to obtain the trained pixel-to-pixel model.

In an optional implementation, the parameter integration model is trained by the following steps:
obtaining a plurality of mesh information samples of the three-dimensional face reconstruction model;
separately inputting the plurality of mesh information samples into a parameter integration model to be trained, to obtain integrated character customization parameter information;
determining reconstructed mesh information of the three-dimensional face reconstruction model based on the integrated character customization parameter information and standard mesh information of a standard three-dimensional face model;
for each of the mesh information samples, determining mesh loss information based on the reconstructed mesh information corresponding to the mesh information sample and the mesh information sample; and
adjusting model parameter information of the parameter integration model based on the mesh loss information to obtain the trained parameter integration model.

According to a second aspect, an embodiment of the present disclosure further provides a face processing apparatus. The apparatus includes:
a first obtaining module configured to obtain three-dimensional face reconstruction coefficients of a three-dimensional face reconstruction model corresponding to face driving image data, and face posture information, where the three-dimensional face reconstruction coefficients include weight coefficients of target basis vectors of reference three-dimensional faces used when three-dimensional face reconstruction is performed on the face driving image data;
a first determination module configured to determine initial character customization parameter information based on the face driving image data; and
a second determination module configured to determine target character customization parameter information of the face driving image data based on the initial character customization parameter information, the three-dimensional face reconstruction coefficients, and the face posture information, where the target character customization parameter information is used to render a virtual character in a virtual scene.

According to a third aspect, an embodiment of the present disclosure further provides a computer device. The computer device includes: a processor, a memory, and a bus, where the memory stores machine-readable instructions executable by the processor, the processor communicates with the memory through the bus when the computer device is running, and the machine-readable instructions, when executed by the processor, cause the steps of the first aspect described above, or the steps of any one of the possible implementations in the first aspect to be performed.

According to a fourth aspect, an embodiment of the present disclosure further provides a computer-readable storage medium having stored thereon a computer program that, when run by a processor, causes the steps of the first aspect described above, or the steps of any one of the possible implementations in the first aspect to be performed.

According to the face processing method provided in the embodiments of the present disclosure, the initial character customization parameter information is first determined based on the face driving image data, and then the target character customization parameter information of the face driving image data is determined based on the initial character customization parameter information, the three-dimensional face reconstruction coefficients, and the face posture information. In the process described above, the three-dimensional face reconstruction coefficients are added to generate the target character customization parameter information, which can not only increase the degree of freedom of character customization to a specific extent, but also avoid to a specific extent an unreasonable face customized based on only the initial parameter information; and the face posture information is added so that a generated virtual character can have a face posture of the face driving image data, thereby improving the similarity between the generated virtual character and the face driving image data.

Further, in the embodiments of the present disclosure, at least two types of loss information, namely, the first loss information between the first image feature of the face driving image data sample and the second image feature of the first generated face image, and the second loss information between the first facial key point information of the face driving image data sample and the second facial key point information of the second generated face image, are used to train the character customization parameter prediction model, so that the character customization parameter information predicted by the trained character customization parameter prediction model can be more accurate and reliable. Furthermore, the facial key point information may be facial key point information of the target part (for example, an eye and a mouth), so that the target part of the virtual character rendered based on the predicted character customization parameter information may be more similar to the target part in the face driving image data sample.

Further, in the embodiments of the present disclosure, the generator used in the process of training the character customization parameter prediction model may be trained based on the character customization parameter information, and the reconstruction coefficient information and the face posture information of the three-dimensional face reconstruction model. The face posture information is used as an input so that the generator generates a face image accurately in case of a face posture at any angle, thereby improving the accuracy of the trained character customization parameter prediction model.

In order to make the above objectives, features, and advantages of the present disclosure more obvious and comprehensible, a detailed description will be provided below with reference to the preferred embodiments and in conjunction with the accompanying drawings.

### BRIEF DESCRIPTION OF DRAWINGS

In order to more clearly illustrate the technical solutions in the embodiments of the present disclosure, the accompanying drawings for describing the embodiments will be briefly described below. The accompanying drawings herein, which are incorporated into and form a part of the description, show the embodiments in line with the present disclosure and are used in conjunction with the description to illustrate the technical solutions of the present disclosure. It should be understood that the following accompanying drawings only show some embodiments of the present disclosure, and therefore should not be considered as a limitation on the scope. For those of ordinary skill in the art, other related accompanying drawings can be derived from these accompanying drawings without creative efforts.

FIG. 1 is a flowchart of a face processing method according to an embodiment of the present disclosure;

FIG. 2 is a flowchart of training of a character customization parameter prediction model according to an embodiment of the present disclosure;

FIG. 3 is a flowchart of training of a generator according to an embodiment of the present disclosure;

FIG. 4 is a flowchart of training of a parameter integration model according to an embodiment of the present disclosure;

FIG. 5 is a flowchart of another face processing method according to an embodiment of the present disclosure;

FIG. 6 is a schematic diagram of a face processing apparatus according to an embodiment of the present disclosure; and

FIG. 7 is a schematic diagram of a computer device according to an embodiment of the present disclosure.

### DETAILED DESCRIPTION OF THE INVENTION

In order to make the objectives, technical solutions, and advantages of embodiments of the present disclosure clearer, the technical solutions in the embodiments of the present disclosure will be clearly and completely described below with reference to the accompanying drawings in the embodiments of the present disclosure. Apparently, the described embodiments are merely some rather than all of the embodiments of the present disclosure. In general, the components of the embodiments of the present disclosure described and shown in the accompanying drawings herein can be arranged and designed in various configurations. Therefore, the following detailed description of the embodiments of the present disclosure, which are set forth in the accompanying drawings, is not intended to limit the scope of protection of the present disclosure, but merely represents selected embodiments of the present disclosure. All other embodiments obtained by those skilled in the art based on the embodiments of the present disclosure without creative efforts shall fall within the scope of protection of the present disclosure.

In related solutions in which a game character is created using a character customization feature, face driving image data is usually input into a pre-trained face recognition network or face segmentation network to obtain character customization parameters, and then the character customization parameters are adjusted to render the game character. However, in the above solutions, there are still significant differences between the game character rendered based on the character customization parameters and the face driving image data.

In view of this, the present disclosure provides a face processing method. Initial character customization parameter information is first determined based on face driving image data, and then target character customization parameter information of the face driving image data is determined based on the initial character customization parameter information, three-dimensional face reconstruction coefficients, and face posture information. In the process described above, the three-dimensional face reconstruction coefficients are added to generate the target character customization parameter information, which can not only increase the degree of freedom of character customization to a specific extent, but also avoid to a specific extent an unreasonable face customized based on only the initial parameter information; and the face posture information is added so that a generated virtual character can have a face posture of the face driving image data, thereby improving the similarity between the generated virtual character and the face driving image data.

The disadvantages existing in the above solutions and the proposed solutions have been obtained by the inventors through practice and careful research. Therefore, the discovery process of the above problems and the solutions proposed by the present disclosure below for the above problems should all be contributions made by the inventors to the present disclosure during the process for the present disclosure.

It should be noted that similar reference signs and letters refer to similar items in the following accompanying drawings. Therefore, once a specific item is defined in one of the accompanying drawings, it need not be further defined and explained in subsequent accompanying drawings.

First, it should be noted that the face driving image data or face driving image data sample involved in the embodiments of the present disclosure is used after authorization by a control person.

To facilitate an understanding of the embodiments, a face processing method disclosed in an embodiment of the present disclosure is first described in detail. An execution body of the face processing method provided in the embodiment of the present disclosure is generally a computer device with some computing capabilities.

The face processing method provided in the embodiment of the present disclosure is illustrated below by using an example in which the execution body is a server.

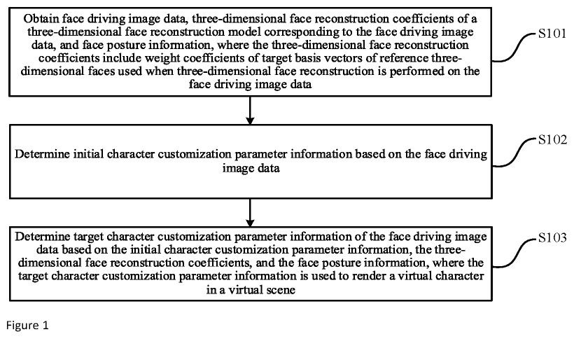

FIG. 1 is a flowchart of a face processing method according to an embodiment of the present disclosure. The method includes S101 to S103.

S101: Obtain three-dimensional face reconstruction coefficients of a three-dimensional face reconstruction model corresponding to face driving image data, and face posture information, where the three-dimensional face reconstruction coefficients include weight coefficients of target basis vectors of reference three-dimensional faces used when three-dimensional face reconstruction is performed on the face driving image data.

In this embodiment of the present disclosure, the face driving image data may refer to an image containing the face of a control person. Here, the image containing the face of the control person may be obtained by acquiring an image of a real person. For example, the image containing the face of the control person may be acquired by taking a photo or a video or the like. It should be noted here that the process of obtaining the face driving image data may be performed after the control person triggers an image acquisition operation, or after authorization by the control person.

The three-dimensional face reconstruction model corresponding to the face driving image data may be obtained using a general three-dimensional face model, such as a general three-dimensional morphable model (3D Morphable Model, 3DMM). In the 3DMM, a face may be represented by three-dimensional feature points, and position information of these three-dimensional feature points may form mesh information of a corresponding face model. Each three-dimensional feature point may be obtained by weighting basis vectors (1, 0, 0), (0, 1, 0), and (0, 0, 1) in three directions of a three-dimensional space. For a three-dimensional feature point (x, y, z), weights of vectors in the three directions are x, y, and z, respectively.

In a specific implementation, mesh information of the face driving image data may be obtained from mesh information of one standard three-dimensional face (i.e., a mean face) and target basis vectors of a plurality of reference three-dimensional faces. The target basis vector may include a basis vector for an identity feature and a basis vector for an expression feature. Specifically, mesh information of the three-dimensional face reconstruction model corresponding to the face driving image data may be obtained according to the formula

$$S = \overline{S} + {\sum }_{i = 1}^{m - 1} {α}_{i} {s}_{{id}_{i}} + {\sum }_{j = 1}^{n - 1} {β}_{j} {s}_{{exp}_{j}} ,$$

where S represents the mesh information of the face driving image data, S̅ represents the mesh information of the standard three-dimensional face, s_{id} represents a basis vector for the identity feature, αᵢ represents a weight coefficient of the basis vector for the identity feature, m represents the number of standard three-dimensional faces, sₑₓₚ represents a basis vector for the expression feature, βⱼ represents a weight coefficient of the basis vector for the expression feature, and n represents the number of expressions of each standard three-dimensional face. Here, the mesh information of the standard three-dimensional face (i.e., the mean face) and the target basis vectors of the plurality of the reference three-dimensional faces may be obtained based on facial scan data of other real faces.

That is, a three-dimensional face reconstruction model with facial features similar to those in the face driving image data may be obtained by performing weighted summation on the mesh information of the standard three-dimensional face (i.e., the mean face), and the basis vectors for the identity feature and the basis vectors for the expression feature of the plurality of reference three-dimensional faces, where the weight coefficient αᵢ of the basis vector for the identity feature and the weight coefficient βⱼ of the basis vector for the expression feature are the three-dimensional face reconstruction coefficients of the three-dimensional face reconstruction model.

In a specific implementation, a model topological relationship between the standard three-dimensional face and the reference three-dimensional faces is a model topological relationship in an open-source model, and is different from a face model topological relationship used in a virtual scene. In one method, point cloud registration wrapping may be used to correspondingly convert the mesh information S̅ of the standard three-dimensional face, the basis vectors s_{id} for the identity feature of the reference three-dimensional faces, and the basis vectors sₑₓₚ for the expression feature of the reference three-dimensional faces that have the model topological relationship in the open-source model into mesh information S̅′ of the standard three-dimensional face, basis vectors s′_{id} for the identity feature of the reference three-dimensional faces, and basis vectors sₑₓₚ for the expression feature of the reference three-dimensional faces that have the face model topological relationship in the virtual scene.

The mesh information S̅′ of the standard three-dimensional face, the basis vectors s′_{id} for the identity feature of the reference three-dimensional faces, and the basis vectors s′ₑₓₚ for the expression feature of the reference three-dimensional faces that have the face model topological relationship in the virtual scene may be used to obtain an initial three-dimensional face reconstruction model corresponding to the face driving image data and having the face model topological relationship in the virtual scene.

In this embodiment of the present disclosure, the face posture information may be face posture information in the face driving image data. Here, the obtained initial three-dimensional face reconstruction model described above may be rotated. When the obtained three-dimensional face reconstruction model is consistent with a face posture in the face driving image data, a rotation angle of the three-dimensional face reconstruction model is the face posture information.

Finally, given a piece of face driving image data, the mesh information corresponding to the three-dimensional face reconstruction model having the face model topological relationship in the virtual scene may be expressed by the following formula:

$${S}^{′} = r ( {\overline{S}}^{′} + {\sum }_{i = 1}^{m - 1} {α}_{i} {s}_{{id}_{i}}^{′} + {\sum }_{j = 1}^{n - 1} {β}_{j} {s}_{{exp}_{j}}^{′} ) ,$$

where r is the face posture information, which may be represented as, (rₓ, r_{y}, r_{z}), and rₓ, r_{y}, r_{z} are rotation components in the three directions respectively.

S102: Determine initial character customization parameter information based on the face driving image data.

S103: Determine target character customization parameter information of the face driving image data based on the initial character customization parameter information, the three-dimensional face reconstruction coefficients, and the face posture information, where the target character customization parameter information is used to render a virtual character in a virtual scene.

In a specific implementation, the face driving image data, the three-dimensional face reconstruction coefficients, and the face posture information may be input into a pre-trained face processing model to obtain the target character customization parameter information. The face processing model includes a character customization parameter prediction model and a parameter integration model. The character customization parameter prediction model is used to generate the initial character customization parameter information based on the face driving image data, and the parameter integration model is used to generate the integrated target character customization parameter information based on the initial character customization parameter information, the three-dimensional face reconstruction coefficients, and the face posture information. Here, the integrated target character customization parameter information contains the three-dimensional face reconstruction coefficients, that is, the three-dimensional face reconstruction coefficients may be represented by the integrated target character customization parameter information. In this case, the three-dimensional face reconstruction coefficients do not need to be directly input into the game engine, thereby avoiding more time to be spent in the rendering process.

That is, the face driving image data, the three-dimensional face reconstruction coefficients, and the face posture information are input into the pre-trained face processing model, the character customization parameter prediction model included in the face processing model may first generate the initial character customization parameter information based on the face driving image data, and then, the parameter integration model included in the face processing model may generate the integrated target character customization parameter information based on the initial character customization parameter information, the three-dimensional face reconstruction coefficients, and the face posture information.

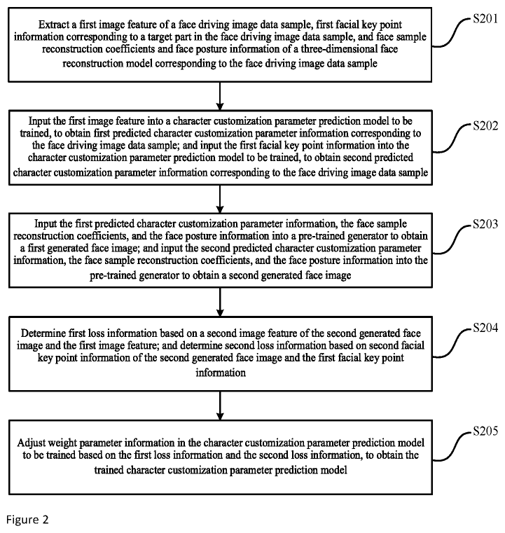

A training process of the character customization parameter prediction model in the face processing model is described below. Referring to a flowchart of training of the character customization parameter prediction model shown in FIG. 2, the character customization parameter prediction model is trained by the following steps.

S201: Extract a first image feature of a face driving image data sample, first facial key point information corresponding to a target part in the face driving image data sample, and face sample reconstruction coefficients and face posture information of a three-dimensional face reconstruction model corresponding to the face driving image data sample.

Here, the first image feature may be a feature of a face in the face driving image data sample. The first image feature may be obtained through face recognition. In an implementation, the first image feature may be obtained using a pre-trained face recognition model, that is, the face driving image data sample is input into the pre-trained face recognition model to obtain the first image feature of the face driving image data sample.

The target part in the face driving image data sample may be a preset facial part, such as an eye, a mouth, a nose, etc. The first facial key point information corresponding to the target part may represent a shape feature of the target part. The first facial key point information corresponding to the target part may be obtained through facial key point detection. In an implementation, the first facial key point information corresponding to the target part in the face driving image data sample may be obtained using a pre-trained facial key point detection model, that is, the face driving image data sample is input into the pre-trained facial key point detection model, so that the first facial key point information corresponding to the target part in the face driving image data sample can be obtained. Here, the facial key point detection model may be pre-trained according to actual needs. For example, in order to enable eyes of a virtual character rendered based on the target character customization parameter information to be more similar to eyes in the face driving image data sample, the facial key point detection model may be trained based on the facial key point information of an eye part, so that the trained facial key point detection model can detect the facial key point information of the eye part more accurately.

The face sample reconstruction coefficients and the face posture information of the three-dimensional face reconstruction model corresponding to the face driving image data sample may be obtained according to the foregoing process of reconstructing the three-dimensional face model, and details are not described herein again.

S202: Input the first image feature into a character customization parameter prediction model to be trained, to obtain first predicted character customization parameter information corresponding to the face driving image data sample; and input the first facial key point information into the character customization parameter prediction model to be trained, to obtain second predicted character customization parameter information corresponding to the face driving image data sample.

S203: Input the first predicted character customization parameter information, the face sample reconstruction coefficients, and the face posture information into a pre-trained generator to obtain a first generated face image; and input the second predicted character customization parameter information, the face sample reconstruction coefficients, and the face posture information into the pre-trained generator to obtain a second generated face image.

In this embodiment of the present disclosure, the pre-trained generator can obtain the generated face images based on the character customization parameter information, the face sample reconstruction coefficients, and the face posture information. In order to avoid problems that the generator needs to adapt to large picture changes due to the introduction of the face posture information and that contents of pictures generated based on the face posture information vary greatly, in a specific implementation, during training of the generator, bone parameter information corresponding to the character customization parameter information may be first determined, then final positions of feature points in the mesh information are obtained through skinning, next, a rendering result is obtained using a differentiable rendering engine, and then, the rendering result obtained by the differentiable rendering engine is processed into a rendering result of a 3D engine. A training process of the generator is described in detail below.

S204: Determine first loss information based on a second image feature of the second generated face image and the first image feature; and determine second loss information based on second facial key point information of the second generated face image and the first facial key point information.

In this embodiment of the present disclosure, the second image feature may be a feature of a face in the second generated face image. In an implementation, the second image feature may also be obtained using the pre-trained face recognition model, that is, the second generated face image is input into the pre-trained face recognition model to obtain the second image feature of the second generated face image.

In one method, the first loss information between the second image feature and the first image feature may be calculated based on a cosine loss function. Here, the first image feature may be denoted as x₁^{id}, and the second image feature is denoted as x₂^{id}. Thus, the first loss information is

$${L}_{1} = 1 - \frac{{x}_{2}^{id} \cdot {x}_{1}^{id}}{‖ {x}_{2}^{id} ‖ ‖ {x}_{1}^{id} ‖} .$$

The second facial key point information may be key point information of a target part in the second generated face image. The target part in the second generated face image is the same facial part as the target part in the face driving image data sample.

In an implementation, first, skinning may be performed on the second predicted character customization parameter information, the face sample reconstruction coefficients, and the face posture information to obtain mesh information corresponding to the second generated face image; and then, the second facial key point information corresponding to the second generated face image is determined based on the mesh information and preset camera parameter information.

Here, calculation for the skinning is mainly carried out on the second predicted character customization parameter information to obtain bone parameter information corresponding to the second predicted character customization parameter information. Then, the mesh information corresponding to the second generated face image is obtained based on the bone parameter information, the face sample reconstruction coefficients, and the face posture information. Next, target feature points corresponding to the target part may be marked in the mesh information corresponding to the second generated face image. Then, according to the marked target feature points and the preset camera parameter information, the mesh information may be projected to obtain position information of the target feature points on the second generated face image, that is, the second facial key point information corresponding to the second generated face image. In an implementation, the first facial key point information may be denoted as x₁^{lmk}, and the second facial key point information is denoted as x₂^{lmk}. Thus, the second loss information is L₂=∥x₂^{lmk}−x₁^{lmk}∥.

S205: Adjust weight parameter information in the character customization parameter prediction model to be trained based on the first loss information and the second loss information, to obtain the trained character customization parameter prediction model.

Here, weighted summation may be performed on the first loss information and the second loss information, obtaining L=w₁L₁+w₂L₂. The weight parameter information in the character customization parameter prediction model is adjusted, thereby obtaining optimal solutions of w₁ and w₂, so that the trained character customization parameter prediction model is obtained.

To improve the prediction accuracy of the character customization parameter prediction model, in an implementation, the training process of the character customization parameter prediction model may further include: obtaining a first facial area image of the face driving image data sample; then, inputting the first facial area image into the character customization parameter prediction model to be trained, to obtain third predicted character customization parameter information corresponding to the face driving image data sample; next, inputting the third predicted character customization parameter information, the face sample reconstruction coefficients, and the face posture information into the pre-trained generator to obtain a third generated face image; and then, determining third loss information based on pixel information of a second facial area image of the third generated face image and pixel information of the first facial area image.

In the above process, the first facial area image may be obtained through image segmentation. Specifically, the face driving image data sample may be input into a pre-trained face segmentation model to obtain the first facial area image of the face driving image data sample.

For the process of generating the third generated face image using the pre-trained generator, reference may be made to the foregoing process, and details are not described herein again.

The second facial area image of the third generated face image may be obtained by inputting the third generated face image into the pre-trained face segmentation model. Then, the third loss information may be determined using pixel value information of each pixel in the second facial area image and pixel value information of each pixel in the first facial area image.

After the third loss information is obtained, the weight parameter information in the character customization parameter prediction model to be trained may be adjusted based on the first loss information, the second loss information, and the third loss information, to obtain the trained character customization parameter prediction model. Here, weighted summation may be performed on the first loss information, the second loss information, and the third loss information to obtain summed loss information, and then the weight parameter information in the character customization parameter prediction model to be trained is adjusted based on the summed loss information.

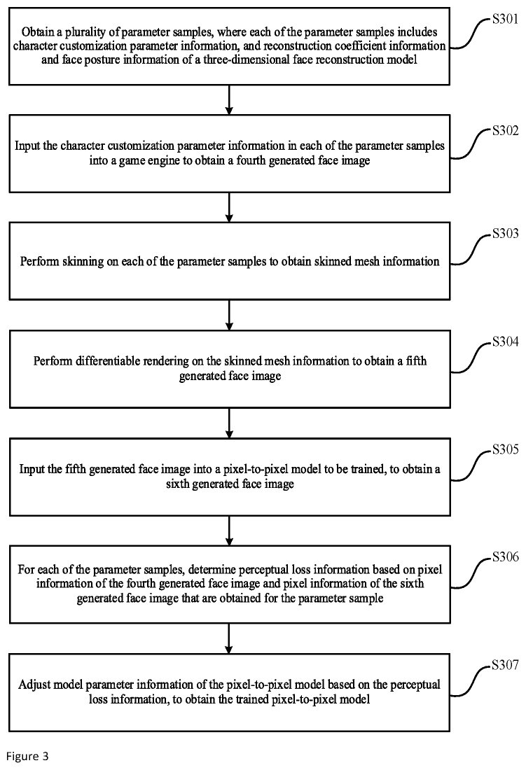

Following the above context, the training process of the generator used in the training process of the character customization parameter prediction model is described in detail below. Referring to a flowchart of training of the generator shown in FIG. 3, in a specific implementation, the generator may include a pixel-to-pixel model. The process of training the generator is mainly a process of training the pixel-to-pixel model. Here, the generator is trained by the following steps.

S301: Obtain a plurality of parameter samples, where each of the parameter samples includes character customization parameter information, and reconstruction coefficient information and the face posture information of the three-dimensional face reconstruction model.

Here, the parameter samples may be obtained through uniform sampling. Here, sampling ranges corresponding to the character customization parameter information, and the reconstruction coefficient information and the face posture information of the three-dimensional face reconstruction model may be set respectively. For example, the sampling range corresponding to the reconstruction coefficient information of the three-dimensional face reconstruction model may be from −3 to 3. The sampling range of the face posture information in a first direction (a left-right direction) may be from −15 degrees to 15 degrees, that is, leftward and rightward swing amplitudes of a face are both 15 degrees. The sampling range of the face posture information in a second direction (an up-down direction, for upward and downward swings) may be from −40 degrees to 40 degrees, that is, upward and downward swing amplitudes of a face are both 40 degrees. The sampling range corresponding to the character customization parameter information is from 0 to 1.

S302: Input the character customization parameter information in each of the parameter samples into a game engine to obtain a fourth generated face image.

S303: Perform skinning on each of the parameter samples to obtain skinned mesh information.

Here, calculation of the skinning is mainly carried out on the character customization parameter information in the parameter samples to obtain corresponding bone parameter information, thereby obtaining the mesh information of the three-dimensional face model corresponding to the fourth generated face image based on the bone parameter information, and the reconstruction coefficient information and the face posture information of the three-dimensional face reconstruction model.

S304: Perform differentiable rendering on the skinned mesh information to obtain a fifth generated face image.

Here, information such as a facial map, camera parameters, and lighting parameters may be preset, so that the fifth generated face image is obtained through the differentiable rendering. The fifth generated face image is an image having a face shape similar to that of the fourth generated face image, although pixel differences exist therebetween.

S305: Input the fifth generated face image into a pixel-to-pixel model to be trained, to obtain a sixth generated face image.

S306: For each of the parameter samples, determine perceptual loss information based on pixel information of the fourth generated face image and pixel information of the sixth generated face image that are obtained for the parameter sample.

Here, the perceptual loss information may be loss information between pixels, that is, loss information between the pixel information of the fourth generated face image and the pixel information of the sixth generated face image. For each parameter sample, the perceptual loss information corresponding to the parameter sample may be obtained.

S307: Adjust model parameter information of the pixel-to-pixel model based on the perceptual loss information, to obtain the trained pixel-to-pixel model.

The trained pixel-to-pixel model can process face images that need pixel processing to obtain face images whose pixel information is more similar to pixel information of the face driving image data, that is, the image obtained through differentiable rendering may be processed into an image that has an effect consistent with that of an image rendered by the game engine.

The generator obtained through the above training can be applied in the training process of the character customization parameter prediction model.

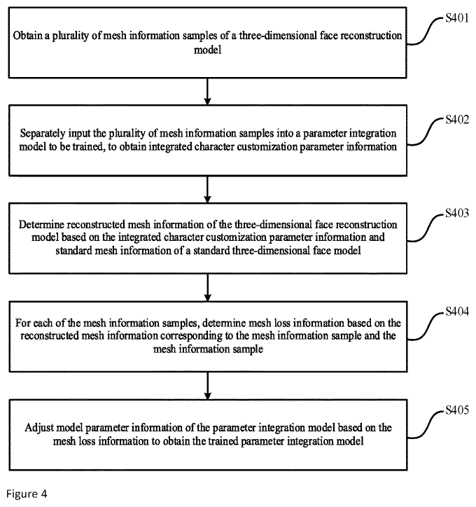

A training process of the parameter integration model in the face processing model is described below. Referring to a flowchart of training of the parameter integration model shown in FIG. 4, the parameter integration model is trained by the following steps.

S401: Obtain a plurality of mesh information samples of the three-dimensional face reconstruction model.

In this embodiment of the present disclosure, three-dimensional face reconstruction may be performed on a plurality of face driving image data samples, so that the plurality of mesh information samples of the three-dimensional face reconstruction model can be obtained.

S402: Separately input the plurality of mesh information samples into a parameter integration model to be trained, to obtain integrated character customization parameter information.

S403: Determine reconstructed mesh information of the three-dimensional face reconstruction model based on the integrated character customization parameter information and standard mesh information of a standard three-dimensional face model.

Here, skinning may be performed on the integrated character customization parameter information to obtain corresponding bone parameter information, and then the reconstructed mesh information of the three-dimensional face reconstruction model is obtained using the bone parameter information and the standard mesh information of the standard three-dimensional face model.

S404: For each of the mesh information samples, determine mesh loss information based on the reconstructed mesh information corresponding to the mesh information sample and the mesh information sample.

Mesh loss information may be determined using a mesh information sample and corresponding reconstructed mesh information. For each mesh information sample, the mesh loss information of the mesh information sample is determined. Here, the mesh information sample may be denoted as S, and the reconstructed mesh information corresponding to the mesh information sample is denoted as S′. Then, the mesh loss information may be Lₘ=∥S′−S∥.

S405: Adjust model parameter information of the parameter integration model based on the mesh loss information to obtain the trained parameter integration model.

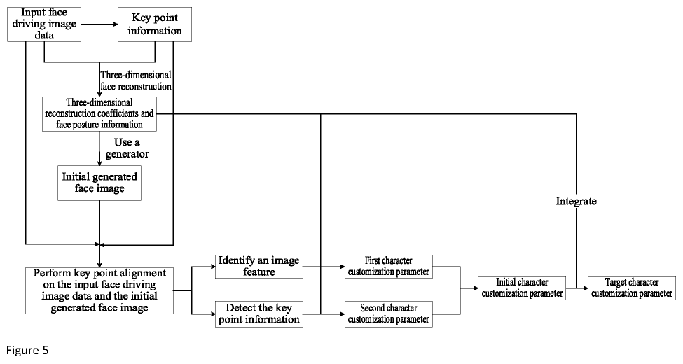

Referring to a flowchart of another face processing method shown in FIG. 5, obtained face driving image data is input into a pre-trained facial key point detection model to obtain first key point information of an eye part and a mouth part. Then, three-dimensional face reconstruction is performed based on the face driving image data and the first key point information to obtain three-dimensional face reconstruction coefficients of a three-dimensional face reconstruction model and face posture information. The three-dimensional face reconstruction coefficients and the face posture information form mesh information of the three-dimensional face reconstruction model corresponding to the face driving image data.

The three-dimensional face reconstruction coefficients and face posture information are input into a trained generator to obtain a generated face image. Then, position information of each key point of the eye part and the mouth part is marked in the mesh information based on the first key point information. Then, the mesh information is projected onto the generated face image based on preset information such as a facial map, camera parameters, and lighting parameters, to obtain position information of each key point on the generated face image, that is, second key point information of the generated face image. Then, the face driving image data is aligned with the generated face image based on the first key point information and the second key point information.

Next, the aligned generated face image is input into a pre-trained face recognition model to obtain a first image feature of the generated face image. The first image feature is input into a trained character customization parameter prediction model, and first character customization parameter information corresponding to the generated face image is obtained based on the first image feature, the three-dimensional face reconstruction coefficients, and the face posture information.

The generated face image is input into the pre-trained facial key point detection model to obtain second key point information of the eye part and the mouth part, and second character customization parameter information is obtained based on the second key point information, the three-dimensional face reconstruction coefficients, and the face posture information.

Then, the first character customization parameter information and the second character customization parameter information are fused to obtain initial character customization parameter information, and then the initial character customization parameter information, the three-dimensional face reconstruction coefficients, and the face posture information are input into a trained parameter integration model to obtain integrated target character customization parameter information.

Those skilled in the art can understand that, in the above methods of the specific implementations, the order in which the steps are written does not imply a strict execution order, and does not constitute any limitation on the implementation process. The specific execution order of the steps should be determined by their functions and possible internal logics.

Based on the same inventive concept, a face processing apparatus corresponding to the face processing methods is further provided in an embodiment of the present disclosure. Because the principle of solving the problems by the apparatus in the embodiment of the present disclosure is similar to that of the face processing methods described above in the embodiments of the present disclosure, for the implementation of the apparatus, reference may be made to the implementations of the methods, and the repetition is not described herein again.

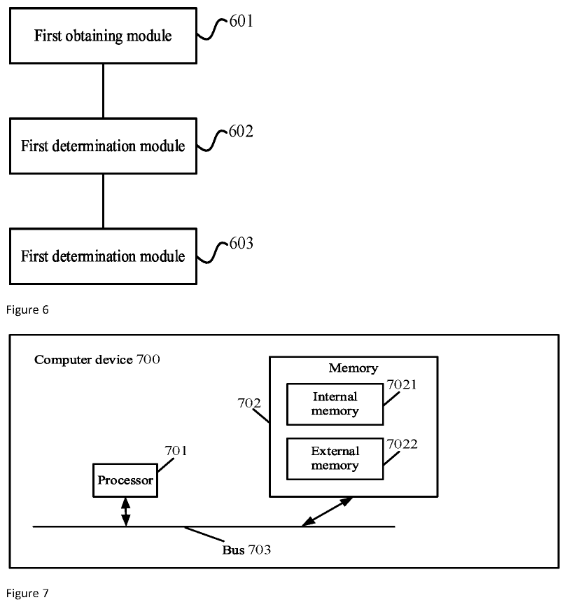

FIG. 6 is a schematic diagram of an architecture of a face processing apparatus according to an embodiment of the present disclosure. The apparatus includes: a first obtaining module 601, a first determination module 602, and a second determination module 603.

The first obtaining module 601 is configured to obtain three-dimensional face reconstruction coefficients of a three-dimensional face reconstruction model corresponding to face driving image data, and face posture information, where the three-dimensional face reconstruction coefficients include weight coefficients of target basis vectors of reference three-dimensional faces used when three-dimensional face reconstruction is performed on the face driving image data.

The first determination module 602 is configured to determine initial character customization parameter information based on the face driving image data.

The second determination module 603 is configured to determine target character customization parameter information of the face driving image data based on the initial character customization parameter information, the three-dimensional face reconstruction coefficients, and the face posture information, where the target character customization parameter information is used to render a virtual character in a virtual scene.

In an optional implementation, the target character customization parameter information is obtained using a pre-trained face processing model;
the face processing model includes a character customization parameter prediction model and a parameter integration model; and
the character customization parameter prediction model is used to generate the initial character customization parameter information based on the face driving image data, and the parameter integration model is used to generate the integrated target character customization parameter information based on the initial character customization parameter information, the three-dimensional face reconstruction coefficients, and the face posture information.

In an optional implementation, the apparatus further includes:
an extraction module configured to extract a first image feature of a face driving image data sample, first facial key point information corresponding to a target part in the face driving image data sample, and face sample reconstruction coefficients and face posture information of a three-dimensional face reconstruction model corresponding to the face driving image data sample;
a first input module configured to input the first image feature into a character customization parameter prediction model to be trained, to obtain first predicted character customization parameter information corresponding to the face driving image data sample; and input the first facial key point information into the character customization parameter prediction model to be trained, to obtain second predicted character customization parameter information corresponding to the face driving image data sample;
a second input module configured to input the first predicted character customization parameter information, the face sample reconstruction coefficients, and the face posture information into a pre-trained generator to obtain a first generated face image; and input the second predicted character customization parameter information, the face sample reconstruction coefficients, and the face posture information into the pre-trained generator to obtain a second generated face image;
a third determination module configured to determine first loss information based on a second image feature of the second generated face image and the first image feature; and determine second loss information based on second facial key point information of the second generated face image and the first facial key point information; and
a first adjustment module configured to adjust weight parameter information in the character customization parameter prediction model to be trained based on the first loss information and the second loss information, to obtain the trained character customization parameter prediction model.

In an optional implementation, the extraction module is specifically configured to: input the face driving image data sample into a pre-trained face recognition model to obtain the first image feature of the face driving image data sample; and
before the third determination module determines the first loss information based on the second image feature of the second generated face image and the first image feature, the apparatus further includes:
a third input module configured to input the second generated face image into the pre-trained face recognition model to obtain the second image feature of the second generated face image.

In an optional implementation, the extraction module is specifically configured to: input the face driving image data sample into a pre-trained facial key point detection model to obtain the first facial key point information corresponding to the target part in the face driving image data sample; and
before the third determination module determines the second loss information based on the second facial key point information of the second generated face image and the first facial key point information, the apparatus further includes:
a first processing module configured to perform skinning on the second predicted character customization parameter information, the face sample reconstruction coefficients, and the face posture information to obtain mesh information corresponding to the second generated face image, where the mesh information includes position information of feature points in a three-dimensional face reconstruction model corresponding to the second generated face image; and a fourth determination module configured to determine the second facial key point information corresponding to the second generated face image based on the mesh information and preset camera parameter information.

In an optional implementation, the apparatus further includes:
a second obtaining module configured to obtain a first facial area image of the face driving image data sample;
a fourth input module configured to input the first facial area image into the character customization parameter prediction model to be trained, to obtain third predicted character customization parameter information corresponding to the face driving image data sample; a fifth input module configured to input the third predicted character customization parameter information, the face sample reconstruction coefficients, and the face posture information into the pre-trained generator to obtain a third generated face image; and
a fifth determination module configured to determine third loss information based on pixel information of a second facial area image of the third generated face image and pixel information of the first facial area image.

The first adjustment module is specifically configured to:
adjust the weight parameter information in the character customization parameter prediction model to be trained based on the first loss information, the second loss information, and the third loss information, to obtain the trained character customization parameter prediction model.

In an optional implementation, the second obtaining module is specifically configured to:
input the face driving image data sample into a pre-trained face segmentation model to obtain the first facial area image of the face driving image data sample; and
before the fifth determination module determines the third loss information based on the pixel information of the second facial area image of the third generated face image and the pixel information of the first facial area image, the apparatus further includes:
a sixth input module configured to input the third generated face image into the pre-trained face segmentation model to obtain the second facial area image of the third generated face image.

In an optional implementation, the pre-trained generator includes a pre-trained pixel-to-pixel model; and the apparatus further includes:
a third obtaining module configured to obtain a plurality of parameter samples, where each of the parameter samples includes character customization parameter information, and reconstruction coefficient information and the face posture information of the three-dimensional face reconstruction model;
a seventh input module configured to input the character customization parameter information in each of the parameter samples into a game engine to obtain a fourth generated face image;
a second processing module configured to perform skinning on each of the parameter samples to obtain skinned mesh information;
a rendering module configured to perform differentiable rendering on the skinned mesh information to obtain a fifth generated face image;
an eighth input module configured to input the fifth generated face image into a pixel-to-pixel model to be trained, to obtain a sixth generated face image;
a sixth determination module configured to, for each of the parameter samples, determine perceptual loss information based on pixel information of the fourth generated face image and pixel information of the sixth generated face image that are obtained for the parameter sample; and
a second adjustment module configured to adjust model parameter information of the pixel-to-pixel model based on the perceptual loss information, to obtain the trained pixel-to-pixel model.

In an optional implementation, the apparatus further includes:
a fourth obtaining module configured to obtain a plurality of mesh information samples of the three-dimensional face reconstruction model;
a ninth input module configured to separately input the plurality of mesh information samples into a parameter integration model to be trained, to obtain integrated character customization parameter information;
a seventh determination module configured to determine reconstructed mesh information of the three-dimensional face reconstruction model based on the integrated character customization parameter information and standard mesh information of a standard three-dimensional face model;
an eighth determination module configured to, for each of the mesh information samples, determine mesh loss information based on the reconstructed mesh information corresponding to the mesh information sample and the mesh information sample; and
a third adjustment module configured to adjust model parameter information of the parameter integration model based on the mesh loss information to obtain the trained parameter integration model.

For the description of the processing processes of various modules in the apparatus, and the interaction processes between the modules, reference may be made to the related description in the above method embodiments, and details are not described herein again.

Based on the same technical concept, an embodiment of the present disclosure further provides a computer device. FIG. 7 is a schematic diagram of a structure of a computer device 700 according to an embodiment of the present disclosure. The computer device includes a processor 701, a memory 702, and a bus 703. The memory 702 is configured to store execution instructions, and includes an internal memory 7021 and an external memory 7022. The internal memory 7021 here is also referred to as a primary memory, which is configured to temporarily store operation data of the processor 701, and data exchanged with the external memory 7022 such as a hard disk. The processor 701 exchanges data with the external memory 7022 through the internal memory 7021. When the computer device 700 is running, the processor 701 communicates with the memory 702 through the bus 703, so that the processor 701 executes the following instructions:
obtaining three-dimensional face reconstruction coefficients of a three-dimensional face reconstruction model corresponding to face driving image data, and face posture information, where the three-dimensional face reconstruction coefficients include weight coefficients of target basis vectors of reference three-dimensional faces used when three-dimensional face reconstruction is performed on the face driving image data;
determining initial character customization parameter information based on the face driving image data; and
determining target character customization parameter information of the face driving image data based on the initial character customization parameter information, the three-dimensional face reconstruction coefficients, and the face posture information, where the target character customization parameter information is used to render a virtual character in a virtual scene.

An embodiment of the present disclosure further provides a computer-readable storage medium having stored thereon a computer program that, when run by a processor, causes the steps of the face processing method described in the above method embodiments to be performed. The storage medium may be a volatile or non-volatile computer-readable storage medium.

An embodiment of the present disclosure further provides a computer program product carrying program code, where instructions included in the program code can be used to perform the steps of the face processing method described in the above method embodiments. For details, reference may be made to the above method embodiments, and details are not described herein again.

The above computer program product may be implemented in the form of hardware, software or a combination thereof. In an optional embodiment, the computer program product is specifically embodied as a computer storage medium. In another optional embodiment, the computer program product is specifically embodied as a software product, such as a software development kit (SDK).

It can be clearly understood by those skilled in the art that, for convenience and brevity of description, for the specific operation processes of the apparatus described above, reference may be made to the corresponding processes in the foregoing method embodiments, and details are not described herein again. In the several embodiments provided in the present disclosure, it should be understood that the disclosed apparatus and method may be implemented in other manners. The apparatus embodiment described above is merely an example. For example, the unit division is merely logical function division and may be other division during actual implementation. For another example, a plurality of units or components may be combined or integrated into another system, or some features may be omitted or not implemented. In addition, the displayed or discussed mutual couplings, direct couplings, or communication connections may be implemented through some communication interfaces. The indirect couplings or communication connections between the apparatuses or units may be implemented in electrical, mechanical, or other forms.

The units described as separate parts may or may not be physically separate, and parts displayed as units may or may not be physical units, and may be located at one position, or may be distributed on a plurality of network units. Some or all of the units may be selected according to actual needs to achieve the objectives of the solutions of the embodiments.

In addition, various functional units in the various embodiments of the present disclosure may be integrated into one processing unit, each of the units may exist alone physically, or two or more units may be integrated into one unit.

If the functions are implemented in the form of a software functional unit and sold or used as an independent product, the functions may be stored in a non-volatile computer-readable storage medium executable by a processor. Based on such an understanding, the technical solutions of the present disclosure essentially, or its contribution to the prior art, or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of the present disclosure. Moreover, the foregoing storage medium includes a USB flash drive, a removable hard disk, a read-only memory (ROM), a random access memory (RAM), a magnetic disk, an optical disc, or other various media that can store program code.

It should be finally noted that the embodiments described above are merely specific implementations of the present disclosure, and used for illustrating rather than limiting the technical solutions of the present disclosure, and the scope of protection of the present disclosure is not limited thereto. Although the present disclosure has been described in detail with reference to the foregoing embodiments, those of ordinary skill in the art should understand that, within the technical scope disclosed in the present disclosure, any person skilled in the art could still modify the technical solutions specified in the foregoing embodiments, or readily figure out any variation thereof, or make equivalent substitution to some of the technical features thereof. However, these modifications, variations, or substitutions do not make the essence of the corresponding technical solutions depart from the spirit and scope of the technical solutions of the embodiments of the present disclosure, and shall fall within the scope of protection of the present disclosure. Therefore, the scope of protection of the present disclosure shall be subject to the scope of protection of the claims.

1. A face processing method, comprising:
obtaining face driving image data, three-dimensional face reconstruction coefficients of a three-dimensional face reconstruction model corresponding to the face driving image data, and face posture information, wherein the three-dimensional face reconstruction coefficients comprise weight coefficients of target basis vectors of reference three-dimensional faces used when three-dimensional face reconstruction is performed on the face driving image data;
determining initial character customization parameter information based on the face driving image data; and
determining target character customization parameter information of the face driving image data based on the initial character customization parameter information, the three-dimensional face reconstruction coefficients, and the face posture information, wherein the target character customization parameter information is used to render a virtual character in a virtual scene.

2. The method according to claim 1, wherein the target character customization parameter information is obtained using a pre-trained face processing model;
the face processing model comprises a character customization parameter prediction model and a parameter integration model; and
the character customization parameter prediction model is used to generate the initial character customization parameter information based on the face driving image data, and the parameter integration model is used to generate the integrated target character customization parameter information based on the initial character customization parameter information, the three-dimensional face reconstruction coefficients, and the face posture information.

3. The method according to claim 2, wherein the character customization parameter prediction model is trained by the following steps:
extracting a first image feature of a face driving image data sample, first facial key point information corresponding to a target part in the face driving image data sample, and face sample reconstruction coefficients and face posture information of a three-dimensional face reconstruction model corresponding to the face driving image data sample;
inputting the first image feature into a character customization parameter prediction model to be trained, to obtain first predicted character customization parameter information corresponding to the face driving image data sample; and inputting the first facial key point information into the character customization parameter prediction model to be trained, to obtain second predicted character customization parameter information corresponding to the face driving image data sample;
inputting the first predicted character customization parameter information, the face sample reconstruction coefficients, and the face posture information into a pre-trained generator to obtain a first generated face image; and inputting the second predicted character customization parameter information, the face sample reconstruction coefficients, and the face posture information into the pre-trained generator to obtain a second generated face image;
determining first loss information based on a second image feature of the second generated face image and the first image feature; and determining second loss information based on second facial key point information of the second generated face image and the first facial key point information; and
adjusting weight parameter information in the character customization parameter prediction model to be trained based on the first loss information and the second loss information, to obtain the trained character customization parameter prediction model.

4. The method according to claim 3, wherein the extracting a first image feature of a face driving image data sample comprises:
inputting the face driving image data sample into a pre-trained face recognition model to obtain the first image feature of the face driving image data sample; and
before the determining first loss information based on a second image feature of the second generated face image and the first image feature, the method further comprises:
inputting the second generated face image into the pre-trained face recognition model to obtain the second image feature of the second generated face image.

5. The method according to claim 3, wherein the extracting first facial key point information corresponding to a target part in the face driving image data sample comprises:
inputting the face driving image data sample into a pre-trained facial key point detection model to obtain the first facial key point information corresponding to the target part in the face driving image data sample; and
before the determining second loss information based on second facial key point information of the second generated face image and the first facial key point information, the method further comprises:
performing skinning on the second predicted character customization parameter information, the face sample reconstruction coefficients, and the face posture information to obtain mesh information corresponding to the second generated face image, wherein the mesh information comprises position information of feature points in a three-dimensional face reconstruction model corresponding to the second generated face image; and
determining the second facial key point information corresponding to the second generated face image based on the mesh information and preset camera parameter information.

6. The method according to claim 3, wherein the step of training the character customization parameter prediction model further comprises:
obtaining a first facial area image of the face driving image data sample;
inputting the first facial area image into the character customization parameter prediction model to be trained, to obtain third predicted character customization parameter information corresponding to the face driving image data sample;
inputting the third predicted character customization parameter information, the face sample reconstruction coefficients, and the face posture information into the pre-trained generator to obtain a third generated face image; and
determining third loss information based on pixel information of a second facial area image of the third generated face image and pixel information of the first facial area image; and
the adjusting weight parameter information in the character customization parameter prediction model to be trained based on the first loss information and the second loss information, to obtain the trained character customization parameter prediction model comprises:
adjusting the weight parameter information in the character customization parameter prediction model to be trained based on the first loss information, the second loss information, and the third loss information, to obtain the trained character customization parameter prediction model.

7. The method according to claim 6, wherein the obtaining a first facial area image of the face driving image data sample comprises:
inputting the face driving image data sample into a pre-trained face segmentation model to obtain the first facial area image of the face driving image data sample; and
before the determining third loss information based on pixel information of a second facial area image of the third generated face image and pixel information of the first facial area image, the method further comprises:
inputting the third generated face image into the pre-trained face segmentation model to obtain the second facial area image of the third generated face image.

8. The method according to claim 3, wherein the pre-trained generator comprises a pre-trained pixel-to-pixel model; and the pixel-to-pixel model is trained by the following steps:
obtaining a plurality of parameter samples, wherein each of the parameter samples comprises character customization parameter information, and reconstruction coefficient information and the face posture information of the three-dimensional face reconstruction model;
inputting the character customization parameter information in each of the parameter samples into a game engine to obtain a fourth generated face image;
performing skinning on each of the parameter samples to obtain skinned mesh information;
performing differentiable rendering on the skinned mesh information to obtain a fifth generated face image;
inputting the fifth generated face image into a pixel-to-pixel model to be trained, to obtain a sixth generated face image;
for each of the parameter samples, determining perceptual loss information based on pixel information of the fourth generated face image and pixel information of the sixth generated face image that are obtained for the parameter sample; and
adjusting model parameter information of the pixel-to-pixel model based on the perceptual loss information, to obtain the trained pixel-to-pixel model.

9. The method according to claim 2, wherein the parameter integration model is trained by the following steps:
obtaining a plurality of mesh information samples of the three-dimensional face reconstruction model;
separately inputting the plurality of mesh information samples into a parameter integration model to be trained, to obtain integrated character customization parameter information;
determining reconstructed mesh information of the three-dimensional face reconstruction model based on the integrated character customization parameter information and standard mesh information of a standard three-dimensional face model;
for each of the mesh information samples, determining mesh loss information based on the reconstructed mesh information corresponding to the mesh information sample and the mesh information sample; and
adjusting model parameter information of the parameter integration model based on the mesh loss information to obtain the trained parameter integration model.

10. (canceled)

11. A computer device, comprising: a processor, a memory, and a bus, wherein the memory stores machine-readable instructions executable by the processor, the processor communicates with the memory through the bus when the computer device is running, and the machine-readable instructions, when executed by the processor, cause:
obtaining face driving image data, three-dimensional face reconstruction coefficients of a three-dimensional face reconstruction model corresponding to the face driving image data, and face posture information, wherein the three-dimensional face reconstruction coefficients comprise weight coefficients of target basis vectors of reference three-dimensional faces used when three-dimensional face reconstruction is performed on the face driving image data;
determining initial character customization parameter information based on the face driving image data; and
determining target character customization parameter information of the face driving image data based on the initial character customization parameter information, the three-dimensional face reconstruction coefficients, and the face posture information, wherein the target character customization parameter information is used to render a virtual character in a virtual scene.

12. A non-volatile computer-readable storage medium having stored thereon a computer program that, when run by a processor, causes:
obtaining face driving image data, three-dimensional face reconstruction coefficients of a three-dimensional face reconstruction model corresponding to the face driving image data, and face posture information, wherein the three-dimensional face reconstruction coefficients comprise weight coefficients of target basis vectors of reference three-dimensional faces used when three-dimensional face reconstruction is performed on the face driving image data;
determining initial character customization parameter information based on the face driving image data; and
determining target character customization parameter information of the face driving image data based on the initial character customization parameter information, the three-dimensional face reconstruction coefficients, and the face posture information, wherein the target character customization parameter information is used to render a virtual character in a virtual scene.

13. (canceled)

14. The computer device according to claim 11, wherein the target character customization parameter information is obtained using a pre-trained face processing model;
the face processing model comprises a character customization parameter prediction model and a parameter integration model; and
the character customization parameter prediction model is used to generate the initial character customization parameter information based on the face driving image data, and the parameter integration model is used to generate the integrated target character customization parameter information based on the initial character customization parameter information, the three-dimensional face reconstruction coefficients, and the face posture information.

15. The computer device according to claim 14, wherein the character customization parameter prediction model is trained by the following steps:
extracting a first image feature of a face driving image data sample, first facial key point information corresponding to a target part in the face driving image data sample, and face sample reconstruction coefficients and face posture information of a three-dimensional face reconstruction model corresponding to the face driving image data sample;
inputting the first image feature into a character customization parameter prediction model to be trained, to obtain first predicted character customization parameter information corresponding to the face driving image data sample; and inputting the first facial key point information into the character customization parameter prediction model to be trained, to obtain second predicted character customization parameter information corresponding to the face driving image data sample;
inputting the first predicted character customization parameter information, the face sample reconstruction coefficients, and the face posture information into a pre-trained generator to obtain a first generated face image; and inputting the second predicted character customization parameter information, the face sample reconstruction coefficients, and the face posture information into the pre-trained generator to obtain a second generated face image;
determining first loss information based on a second image feature of the second generated face image and the first image feature; and determining second loss information based on second facial key point information of the second generated face image and the first facial key point information; and
adjusting weight parameter information in the character customization parameter prediction model to be trained based on the first loss information and the second loss information, to obtain the trained character customization parameter prediction model.

16. The computer device according to claim 15, wherein the extracting a first image feature of a face driving image data sample comprises:
inputting the face driving image data sample into a pre-trained face recognition model to obtain the first image feature of the face driving image data sample; and
before the determining first loss information based on a second image feature of the second generated face image and the first image feature, the method further comprises:
inputting the second generated face image into the pre-trained face recognition model to obtain the second image feature of the second generated face image.

17. The computer device according to claim 15, wherein the extracting first facial key point information corresponding to a target part in the face driving image data sample comprises:
inputting the face driving image data sample into a pre-trained facial key point detection model to obtain the first facial key point information corresponding to the target part in the face driving image data sample; and
before the determining second loss information based on second facial key point information of the second generated face image and the first facial key point information, the method further comprises:
performing skinning on the second predicted character customization parameter information, the face sample reconstruction coefficients, and the face posture information to obtain mesh information corresponding to the second generated face image, wherein the mesh information comprises position information of feature points in a three-dimensional face reconstruction model corresponding to the second generated face image; and
determining the second facial key point information corresponding to the second generated face image based on the mesh information and preset camera parameter information.

18. The computer device according to claim 15, wherein the step of training the character customization parameter prediction model further comprises:
obtaining a first facial area image of the face driving image data sample;
inputting the first facial area image into the character customization parameter prediction model to be trained, to obtain third predicted character customization parameter information corresponding to the face driving image data sample;
inputting the third predicted character customization parameter information, the face sample reconstruction coefficients, and the face posture information into the pre-trained generator to obtain a third generated face image; and
determining third loss information based on pixel information of a second facial area image of the third generated face image and pixel information of the first facial area image; and
the adjusting weight parameter information in the character customization parameter prediction model to be trained based on the first loss information and the second loss information, to obtain the trained character customization parameter prediction model comprises:
adjusting the weight parameter information in the character customization parameter prediction model to be trained based on the first loss information, the second loss information, and the third loss information, to obtain the trained character customization parameter prediction model.

19. The computer device according to claim 18, wherein the obtaining a first facial area image of the face driving image data sample comprises:
inputting the face driving image data sample into a pre-trained face segmentation model to obtain the first facial area image of the face driving image data sample; and
before the determining third loss information based on pixel information of a second facial area image of the third generated face image and pixel information of the first facial area image, the method further comprises:
inputting the third generated face image into the pre-trained face segmentation model to obtain the second facial area image of the third generated face image.

20. The computer device according to claim 15, wherein the pre-trained generator comprises a pre-trained pixel-to-pixel model; and the pixel-to-pixel model is trained by the following steps:
obtaining a plurality of parameter samples, wherein each of the parameter samples comprises character customization parameter information, and reconstruction coefficient information and the face posture information of the three-dimensional face reconstruction model;
inputting the character customization parameter information in each of the parameter samples into a game engine to obtain a fourth generated face image;
performing skinning on each of the parameter samples to obtain skinned mesh information;
performing differentiable rendering on the skinned mesh information to obtain a fifth generated face image;
inputting the fifth generated face image into a pixel-to-pixel model to be trained, to obtain a sixth generated face image;
for each of the parameter samples, determining perceptual loss information based on pixel information of the fourth generated face image and pixel information of the sixth generated face image that are obtained for the parameter sample; and
adjusting model parameter information of the pixel-to-pixel model based on the perceptual loss information, to obtain the trained pixel-to-pixel model.

21. The computer device according to claim 14, wherein the parameter integration model is trained by the following steps:
obtaining a plurality of mesh information samples of the three-dimensional face reconstruction model;
separately inputting the plurality of mesh information samples into a parameter integration model to be trained, to obtain integrated character customization parameter information;
determining reconstructed mesh information of the three-dimensional face reconstruction model based on the integrated character customization parameter information and standard mesh information of a standard three-dimensional face model;
for each of the mesh information samples, determining mesh loss information based on the reconstructed mesh information corresponding to the mesh information sample and the mesh information sample; and
adjusting model parameter information of the parameter integration model based on the mesh loss information to obtain the trained parameter integration model.

22. The non-volatile computer-readable storage medium according to claim 12, wherein the target character customization parameter information is obtained using a pre-trained face processing model;
the face processing model comprises a character customization parameter prediction model and a parameter integration model; and
the character customization parameter prediction model is used to generate the initial character customization parameter information based on the face driving image data, and the parameter integration model is used to generate the integrated target character customization parameter information based on the initial character customization parameter information, the three-dimensional face reconstruction coefficients, and the face posture information.
